(19) United States
(12) Patent Application Publication
(10) Pub. No.: US 2014/0111150 A1
(43) Pub. Date: Apr. 24, 2014

(54) CURSOR CONTROL DEVICE

(71) Applicant: PRIMAX ELECTRONICS LTD., Taipei (TW)

(72) Inventor: Xiang-Hui Deng, Taipei (TW)

(73) Assignee: PRIMAX ELECTRONICS LTD., Neihu (TW)

(21) Appl. No.: 13/737,674

(22) Filed: Jan. 9, 2013

(30) Foreign Application Priority Data
Oct. 19, 2012 (CN) 201220538069.6

(51) Int. Cl. H02J 7/00

(52) U.S. Cl. CPC H02J 7/0042
USPC 320/108

(57) ABSTRACT

A cursor control device includes a main body, a primary circuit board, a conducting member, a chargeable battery, and a wireless signal receiver. The conducting member is connected with the primary circuit board. The main body includes a charging slot. A first bulge is protruded from an inner periphery of the charging slot. A recess is formed in an outer shell of the wireless signal receiver. The wireless signal receiver has a charging plate member exposed to the outer shell. When the wireless signal receiver is transferred through the charging slot, the first bulge is accommodated within the recess of the outer shell of the wireless signal receiver, and the charging plate member is contacted with the conducting member. When the wireless signal receiver is connected with a computer, the electric power from the computer is transmitted to the chargeable battery.

### FIELD OF THE INVENTION

The present invention relates to a cursor control device, and more particularly to a chargeable cursor control device.

### BACKGROUND OF THE INVENTION

A cursor control device such as a mouse is an essential input device for operating a computer. Generally, the use of the mouse may control a cursor shown on a display screen in order to move the cursor to a target site. Moreover, by clicking a left button or a right button of the mouse, a variety of functions are implemented. For example, the function of selecting characters or the function of opening a program may be implemented by operating the mouse.

The commercially available mouse devices are usually classified into two types, i.e. a wired mouse and a wireless mouse. The wired mouse is connected with the computer through a transmission wire in order for acquiring electric power and transmitting signals. The wireless mouse is in communication with the computer through a wireless signal receiver, which is connected with the computer. In addition, the wireless mouse is usually equipped with a built-in chargeable battery for providing electric power to the wireless mouse.

In a case that the residual electric power of the chargeable battery is insufficient, the wireless mouse fails to be normally operated. For providing normal operations of the wireless mouse, many methods for charging the wireless mouse have been disclosed. Hereinafter, a method for charging a conventional chargeable cursor control device will be illustrated with reference to FIGS. 1 and 2. FIG. 1 is a schematic perspective view illustrating the outward appearance of a conventional chargeable cursor control device. FIG. 2 schematically illustrates a charging slot of the conventional chargeable cursor control device of FIG. 1. For example, the chargeable cursor control device is a chargeable wireless mouse.

As shown in FIGS. 1 and 2, the chargeable wireless mouse 1 comprises a first mouse body 10, a second mouse body 11, and a charging slot 12. The first mouse body 10 comprises a first surface 101.

Moreover, a charging slot cover 13 is disposed on the first surface 101 of the first mouse body 10 for sheltering the charging slot 12, which is disposed under the charging slot cover 13. When the charging slot cover 13 is opened relative to the charging slot 12, the charging slot 12 is exposed.

In addition, a chargeable battery 14 is disposed within the second mouse body 11 for providing electric power to the wireless mouse 1.

Moreover, a wireless signal receiver 15 is also shown in FIG. 1. The wireless signal receiver 15 comprises a holding part 16, a connecting part 17, and a charging plate 18. The connecting part 17 is located at an end of the holding part 16 to be connected with a connecting port of a computer (not shown). The charging plate 18 is exposed outside the holding part 16.

Hereinafter, the inner structure of the charging slot 12 will be illustrated with reference to FIG. 2. As shown in FIG. 2, the charging slot cover 13 is opened, and thus the charging slot 12 is exposed. A conducting part 19 is disposed within the charging slot 12. In addition, the conducting part 19 is connected with a primary circuit board (not shown) for transmitting the electric power. The primary circuit board is disposed within the first mouse body 10.

For charging the wireless mouse, the wireless signal receiver 15 is firstly aligned with the charging slot 12 of the wireless mouse 1, and then the holding part 16 of the wireless signal receiver 15 is completely inserted into the charging slot 12.

After the holding part 16 of the wireless signal receiver 15 is inserted into the charging slot 12, the wireless signal receiver 15 is fixed in the charging slot 12. In addition, the connecting part 17 of the wireless signal receiver 15 is protruded over the first surface 101 of the wireless mouse 1.

Moreover, when the wireless signal receiver 15 is inserted into the charging slot 12, the charging plate 18 of the wireless signal receiver 15 is contacted with the conducting part 19 within the charging slot 12.

After the connecting part 17 is connected with the connecting port of the computer, the electric power is transmitted from the computer to the wireless signal receiver 15 through the connecting port. Consequently, the electric power is transmitted to the charging plate 18 and the conducting part 19. Then, the electric power is transmitted from the conducting part 19 to the primary circuit board, which is disposed within the first mouse body 10 and connected with the conducting part 19. Afterwards, the electric power is transmitted from the primary circuit board to the chargeable battery 14 within the second mouse body 11. In such way, the electric power from the computer can be transmitted to the chargeable battery 14.

From the above discussions, the chargeable cursor control device has no foolproof structure for preventing the holding part 16 of the wireless signal receiver 15 from being inserted into the charging slot 12 in a wrong direction (e.g. a reverse direction). For normally transferring the electric power, the charging plate 18 of the wireless signal receiver 15 should be contacted with the conducting part 19 within the charging slot 12. If the holding part 16 of the wireless signal receiver 15 is inserted into the charging slot 12 in the wrong direction, the charging task fails to be performed. Under this circumstance, the user may try inserting the wireless signal receiver 15 into the charging slot 12 in different directions to normally perform the charging task. If the wireless signal receiver 15 is frequently inserted into the charging slot 12 in the wrong direction, the charging plate 18 and the conducting part 19 are possibly damaged and thus unable to transfer the electric power.

Therefore, there is a need of providing an improved chargeable cursor control device in order to eliminate the above drawbacks.

### SUMMARY OF THE INVENTION

The present invention provides a chargeable cursor control device with a mechanism for preventing a wireless signal receiver from being inserted into a charging slot in a wrong direction.

In accordance with an aspect of the present invention, there is provided a cursor control device. The cursor control device includes a main body, a primary circuit board, a conducting member, a chargeable battery, and a wireless signal receiver. The main body includes a charging slot and a first bulge. The first bulge is protruded from an inner periphery of the charging slot. The primary circuit board is disposed within the main body. The conducting member is connected with the primary circuit board. The chargeable battery is disposed within the main body, and connected with the primary circuit board. The wireless signal receiver is connectable with a connecting port of a computer. The wireless signal receiver includes an outer shell, a receiver circuit board, a connecting terminal, and a charging plate member. The outer shell includes a recess. The recess is formed in a first sidewall of the outer shell. The receiver circuit board is disposed within the outer shell. The connecting terminal is located at an end of the outer shell. When the connecting terminal is connected with the connecting port of the computer, electric power is transmitted from the computer to the receiver circuit board through the connecting terminal. The charging plate member is connected with the receiver circuit board, and exposed to a second sidewall of the outer shell. When the wireless signal receiver is transferred through the charging slot, the first bulge protruded from the charging slot is accommodated within the recess of the outer shell of the wireless signal receiver, and the connecting terminal is exposed outside the main body to be connected with the computer, so that the charging plate member is contacted with the conducting member to receive the electric power from the computer and transmit the electric power to the chargeable battery.

In an embodiment, the conducting member includes a conducting member positive electrode and a conducting member negative electrode, and the charging plate member includes a charging plate positive electrode and a charging plate negative electrode. The conducting member positive electrode and conducting member negative electrode are respectively contacted with the charging plate positive electrode and the charging plate negative electrode to transfer the electric power.

In an embodiment, the cursor control device further includes a charging slot cover and an elastic element. The charging slot cover is used for sheltering the charging slot. The charging slot cover is rotatable relative to the charging slot. The elastic element is used for providing a restoring force to the charging slot cover.

In an embodiment, the conducting member is a resilient sheet.

In an embodiment, the cursor control device is a mouse.

In an embodiment, the main body includes an upper body part and a lower body part. The charging slot is formed in the lower body part. A receiving space is disposed within the upper body part. A bottom of the wireless signal receiver is fixed in the receiving space.

In an embodiment, the cursor control device includes a first magnetic body and a second magnetic body. The first magnetic body is disposed on a bottom of the receiving space. The second magnetic body is disposed on the bottom of the wireless signal receiver. When the first magnetic body and the second magnetic body are magnetically attracted by each other, the wireless signal receiver is fixed in the main body.

In an embodiment, the cursor control device further includes a secondary circuit board, which is disposed within a rear end of the main body. The electric power of the chargeable battery is transmitted to the primary circuit board through the secondary circuit board.

In an embodiment, the cursor control device further includes a switch, wherein the switch is disposed on the secondary circuit board.

In an embodiment, the cursor control device further includes a storing part, which is disposed within the rear end of the main body for storing the wireless signal receiver. If the wireless signal receiver is not stored within the storing part, the switch is triggered by the storing part, so that the electric power of the chargeable battery is permitted to be transmitted to the primary circuit board. When the wireless signal receiver is inserted into the storing part, the storing part is pushed by the wireless signal receiver, so that the switch is not triggered.

In an embodiment, the main body includes a first casing, a second casing, and a connecting member. The first casing includes a first upper casing part and a first lower casing part. The primary circuit board is disposed within the first casing. The charging slot is formed in the first lower casing part. The first upper casing part includes a receiving space. A bottom of the wireless signal receiver is accommodated within the receiving space. The chargeable battery is disposed within the second casing. The connecting member is used for connecting the first casing and the second casing, so that the second casing is rotatable relative to the first casing.

In an embodiment, the cursor control device further includes a first magnetic body and a second magnetic body. The first magnetic body is disposed on a bottom of the receiving space. The second magnetic body is disposed on the bottom of the wireless signal receiver. When the first magnetic body and the second magnetic body are magnetically attracted by each other, the wireless signal receiver is fixed in the first casing.

In an embodiment, the connecting member includes a first supporting frame, a second supporting frame, an elastic pad, a cam, a positioning plate, a fixing plate, and a rotating shaft. The first supporting frame is connected with a rear end of the first casing, and includes an engaging groove and two second bulges. The second supporting frame is connected with a front end of the second casing. The cam includes a third bulge. When the first supporting frame and the second supporting frame are aligned with each other, the third bulge is engaged with the engaging groove of the first supporting frame. As the second casing is rotated, the third bulge is disengaged from the engaging groove and the elastic pad is compressed by the third bulge. As the second casing is rotated, the positioning plate is correspondingly rotated until the positioning plate is stopped by one of the second bulges. The rotating shaft is penetrated through the elastic pad, the cam, the first supporting frame, the positioning plate, the second supporting frame and the fixing plate sequentially. As the second casing is rotated, the rotating shaft, the fixing plate, the positioning plate and the cam are synchronously rotated.

In an embodiment, the cursor control device further includes a secondary circuit board, which is disposed within the second casing. The electric power of the chargeable battery is transmitted to the primary circuit board through the secondary circuit board.

In an embodiment, the cursor control device further includes a switch, wherein the switch is disposed on the secondary circuit board.

In an embodiment, the cursor control device further includes a storing part, which is disposed within the second casing for storing the wireless signal receiver. If the wireless signal receiver is not stored within the storing part, the switch is triggered by the storing part, so that the electric power of the chargeable battery is permitted to be transmitted to the primary circuit board. When the wireless signal receiver is inserted into the storing part, the storing part is pushed by the wireless signal receiver, so that the switch is not triggered.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional chargeable cursor control device;

FIG. 2 schematically illustrates a charging slot of the conventional chargeable cursor control device of FIG. 1;

FIG. 3 is a schematic perspective view illustrating the outward appearance of a cursor control device according to a first embodiment of the present invention, in which a charging slot cover is closed;

FIG. 4 is a schematic perspective view illustrating the outward appearance of the cursor control device according to the first embodiment of the present invention, in which the charging slot cover is opened;

FIG. 5 is a schematic perspective view illustrating the inner structure of a main body of the cursor control device according to the first embodiment of the present invention;

FIG. 6 is a schematic exploded view illustrating a wireless signal receiver of the cursor control device according to the first embodiment of the present invention;

FIG. 7 is a schematic assembled view illustrating the wireless signal receiver of the cursor control device according to the first embodiment of the present invention;

FIG. 8 is a schematic perspective view illustrating the outward appearance of the cursor control device according to the first embodiment of the present invention, in which the wireless signal receiver is inserted into the charging slot;

FIG. 9 is a schematic partial perspective view illustrating the inner structure of the cursor control device according to the first embodiment of the present invention, in which the wireless signal receiver is inserted into the charging slot;

FIG. 10 schematically illustrates the connection between a computer and the cursor control device according to the first embodiment of the present invention;

FIG. 11 is a schematic exploded view illustrating the outward appearance of a cursor control device according to a second embodiment of the present invention;

FIG. 12 is a schematic exploded view illustrating the inner structure of the cursor control device according to the second embodiment of the present invention;

FIG. 13 is a schematic exploded view illustrating a connecting member of the cursor control device according to the second embodiment of the present invention; and

FIG. 14 is a schematic assembled view illustrating the connecting member of the cursor control device according to the second embodiment of the present invention.

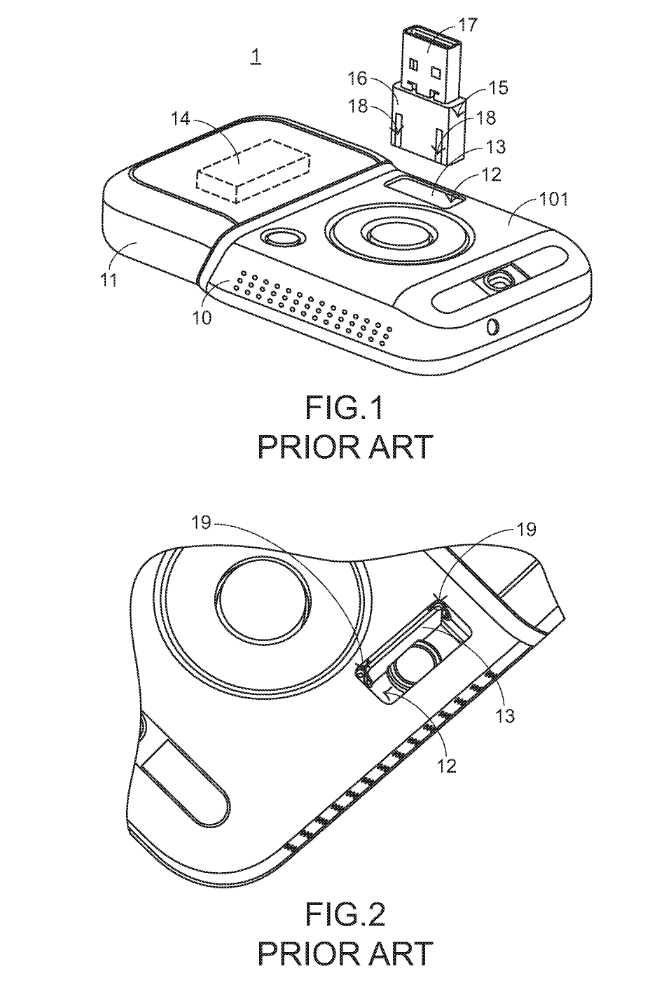

### DETAILED DESCRIPTION OF THE PREFERRED EMBODIMENT

The present invention provides a chargeable cursor control device. In the following embodiment, the cursor control device will be illustrated by referring to a mouse.

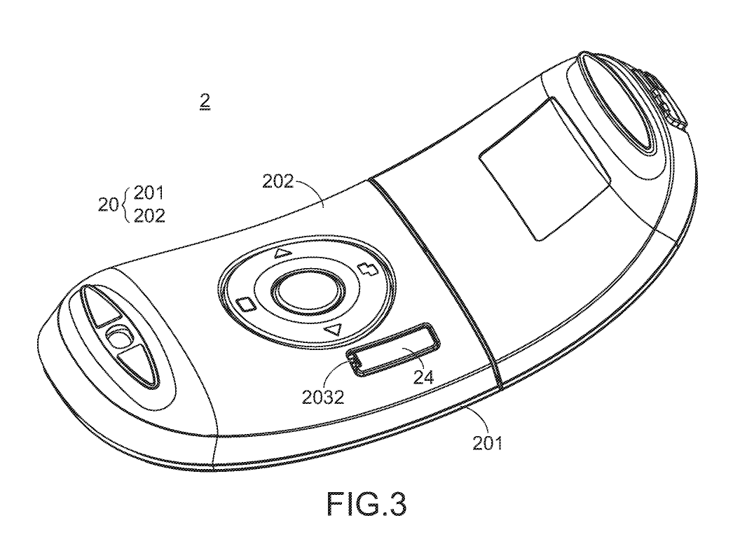

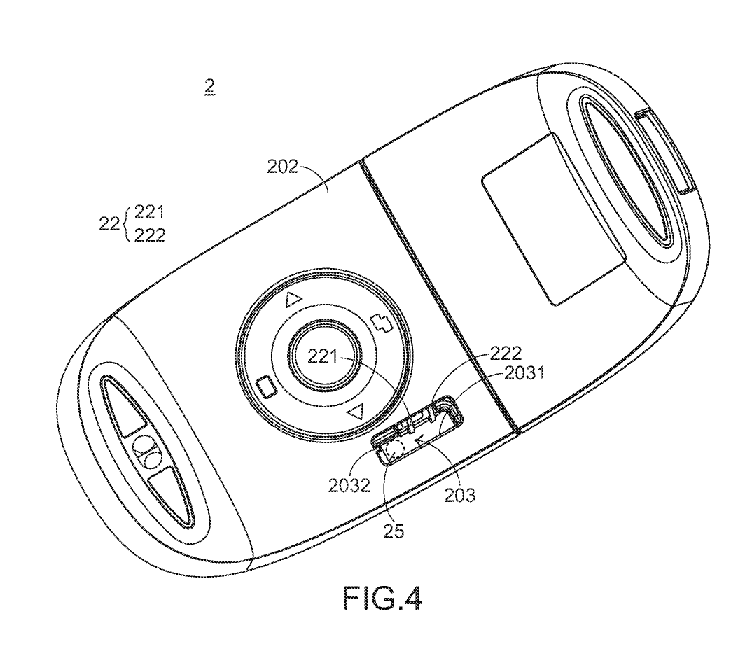

FIG. 3 is a schematic perspective view illustrating the outward appearance of a cursor control device according to a first embodiment of the present invention, in which a charging slot cover is closed. FIG. 4 is a schematic perspective view illustrating the outward appearance of the cursor control device according to the first embodiment of the present invention, in which the charging slot cover is opened.

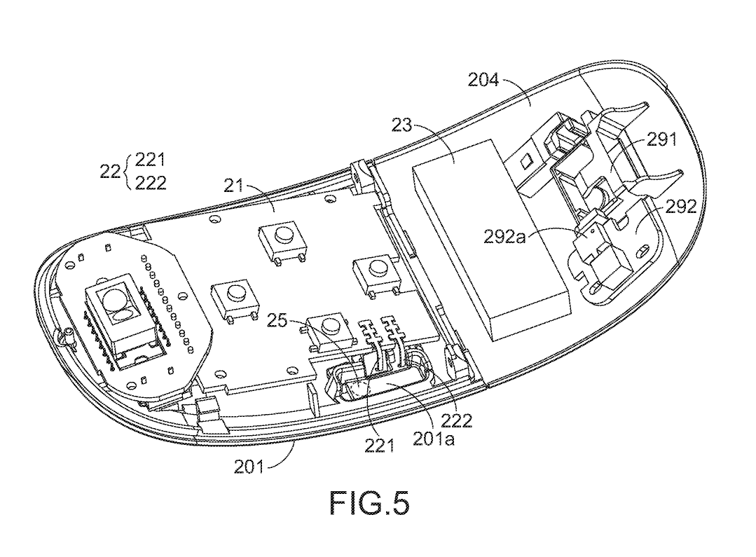

The components of the cursor control device 2 will be illustrated as follows. The cursor control device 2 comprises a main body 20, a primary circuit board 21 (see FIG. 5), a conducting member 22, and a chargeable battery 23 (see FIG. 5).

As shown in FIGS. 3 and 4, the main body 20 comprises an upper body part 201, a lower body part 202, a charging slot 203, and a first bulge 2032. The charging slot 203 is formed in the lower body part 202. The first bulge 2032 is protruded from an inner periphery 2031 of the charging slot 203.

Moreover, the cursor control device 2 further comprises a charging slot cover 24 for sheltering the charging slot 203. The charging slot cover 24 is rotatable relative to the charging slot 203 to expose the charging slot 203 (see FIG. 4).

The relationships between the above components will be illustrated as follows. FIG. 5 is a schematic perspective view illustrating the inner structure of a main body of the cursor control device according to the first embodiment of the present invention.

Firstly, the primary circuit board 21 is disposed within the main body 20. The conducting member 22 is connected with the primary circuit board 21. In this embodiment, the conducting member 22 comprises a conducting member positive electrode 221 and a conducting member negative electrode 222. Moreover, the conducting member 22 is a resilient sheet.

Moreover, a receiving space 201a is disposed within the upper body part 201. As shown in FIG. 5, the receiving space 201a is disposed under the conducting member 22, and a first magnetic body 25 is disposed on a bottom of the receiving space 201a.

Afterwards, the chargeable battery 23 is disposed within the main body 20, and connected with the primary circuit board 21.

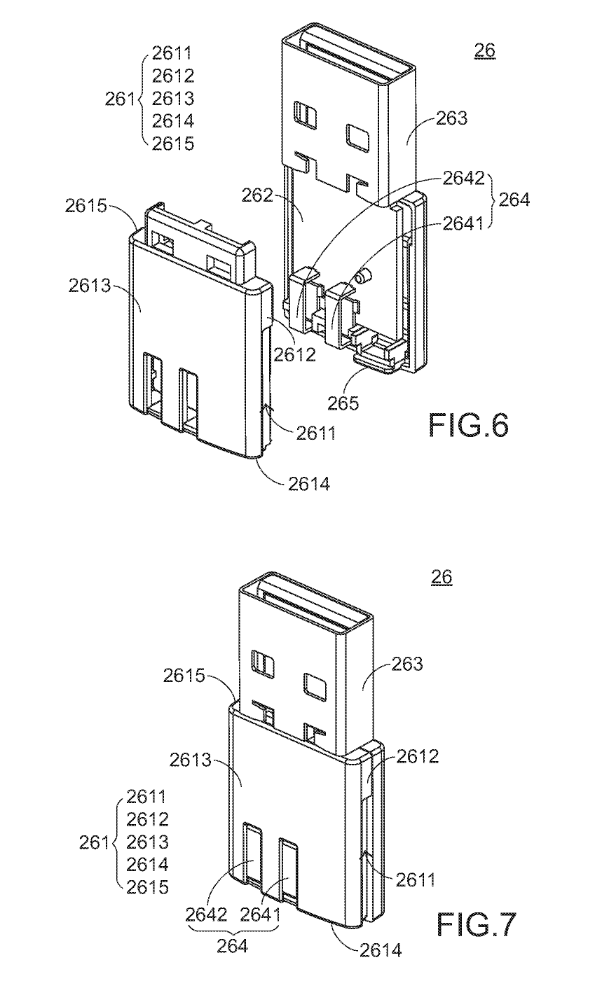

Hereinafter, the structure of a wireless signal receiver will be illustrated with reference to FIGS. 6 and 7. FIG. 6 is a schematic exploded view illustrating a wireless signal receiver of the cursor control device according to the first embodiment of the present invention. FIG. 7 is a schematic assembled view illustrating the wireless signal receiver of the cursor control device according to the first embodiment of the present invention.

As shown in FIGS. 6 and 7, the wireless signal receiver 26 of the cursor control device 2 comprises an outer shell 261, a receiver circuit board 262, a connecting terminal 263, a charging plate member 264, and a second magnetic body 265. The outer shell 261 comprises a recess 2611. The recess 2611 is formed in a first sidewall 2612 of the outer shell 261. Whereas, no recess is formed in a third sidewall 2615, which is parallel with the first sidewall 2612 of the outer shell 261. The charging plate member 264 comprises a charging plate positive electrode 2641 and a charging plate negative electrode 2642. In this embodiment, the connecting terminal 263 is a USB connecting terminal.

A process of assembling the wireless signal receiver 26 will be illustrated as follows. Firstly, the receiver circuit board 262 is disposed within the outer shell 261. The connecting terminal 263 is located at an end of the outer shell 261. The charging plate member 264 is connected with the receiver circuit board 262, and exposed to a second sidewall 2613 of the outer shell 261. In this embodiment, the first sidewall 2612 and the second sidewall 2613 are perpendicular to each other. The second magnetic body 265 is disposed under the receiver circuit board 262, and exposed to a bottom 2614 of the outer shell 261.

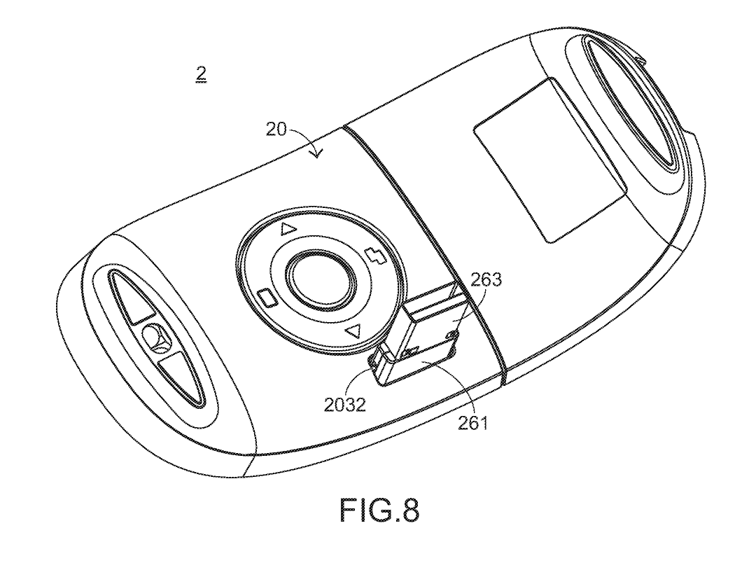

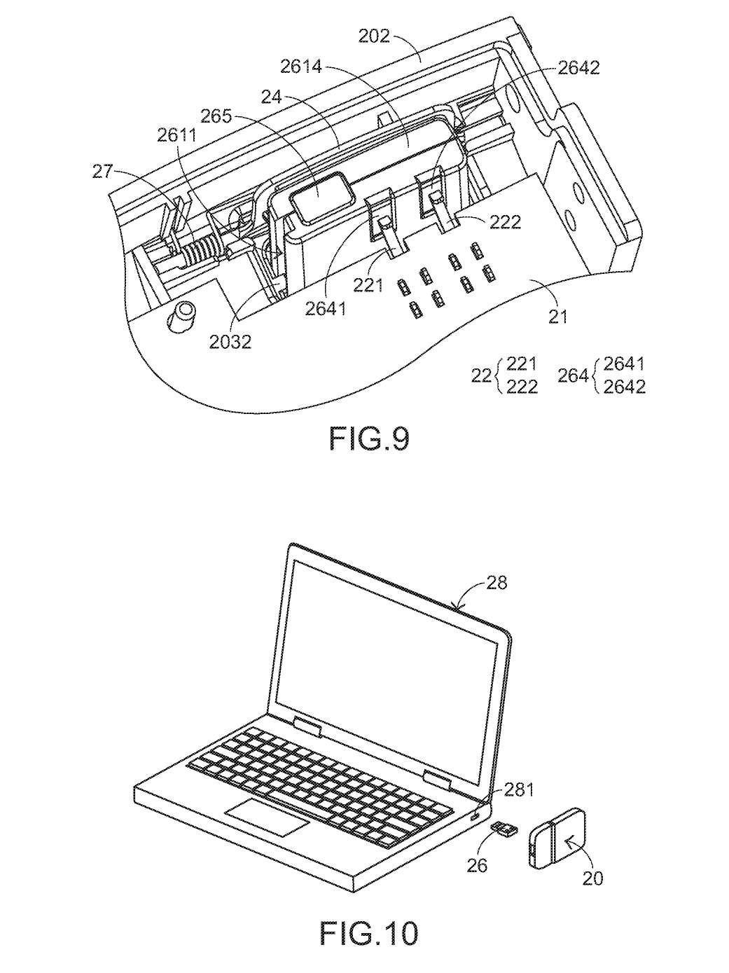

Hereinafter, a process of charging the cursor control device 2 will be illustrated with reference to FIG. 3, FIG. 4 and FIGS. 8-10. FIG. 8 is a schematic perspective view illustrating the outward appearance of the cursor control device according to the first embodiment of the present invention, in which the wireless signal receiver is inserted into the charging slot. FIG. 9 is a schematic partial perspective view illustrating the inner structure of the cursor control device according to the first embodiment of the present invention, in which the wireless signal receiver is inserted into the charging slot. FIG. 10 schematically illustrates the connection between a computer and the cursor control device according to the first embodiment of the present invention.

For charging the cursor control device 2, the outer shell 261 of the wireless signal receiver 26 should be firstly introduced into the charging slot 203 of the main body 20 until the bottom 2614 of the outer shell 261 is inserted into the receiving space 201a within the upper body part 201. Meanwhile, the second magnetic body 265 of the wireless signal receiver 26 and the first magnetic body 25 on the bottom of the receiving space 201a are magnetically attracted by each other. Consequently, the outer shell 261 is fixed in the main body 20.

Then, as shown in FIGS. 8 and 9, the first bulge 2032 is protruded from the inner periphery 2031 of the charging slot 203. For allowing the outer shell 261 of the wireless signal receiver 26 to be successfully transferred through the charging slot 203, the first bulge 2032 should be accommodated within the recess 2611 of the outer shell 261 of the wireless signal receiver 26. On the other hand, if the outer shell 261 is rotated by 180 degrees, the third sidewall 2615 of the outer shell 261 is aligned with the first bulge 2032. Since no recess is formed in the third sidewall 2615, the outer shell 261 is stopped by the first bulge 2032 from being transferred through the charging slot 203.

After the bottom 2614 of the outer shell 261 is inserted into the receiving space 201a within the upper body part 201, the connecting terminal 263 is exposed outside the upper body part 201. In addition, the charging plate positive electrode 2641 of the wireless signal receiver 26 is contacted with the conducting member positive electrode 221 of the main body 20, and the charging plate negative electrode 2642 of the wireless signal receiver 26 is contacted with the conducting member negative electrode 222 of the main body 20.

Moreover, as shown in FIG. 9, the cursor control device 2 further comprises an elastic element 27. The elastic element 27 is connected with the charging slot cover 24 and the lower body part 202 for providing a restoring force to the charging slot cover 24. After the wireless signal receiver 26 is removed from the charging slot 203, the elastic element 27, in response to the restoring force, the charging slot cover 24 is rotated to shelter the charging slot 203 again.

Then, the connecting terminal 263 is inserted into a connecting port 281 of a computer 28 (see FIG. 10). Consequently, the electric power from the computer 28 is transmitted to the receiver circuit board 262 through the connecting port 281. Then, the electric power is transmitted from the receiver circuit board 262 to the primary circuit board 21 through the charging plate member 264 and the conducting member 22. Then, the electric power is transmitted from the primary circuit board 21 to the chargeable battery 23, so that the charging task is started. In this embodiment, the connecting port 281 is a USB connecting port.

Furthermore, as shown in FIG. 5, the cursor control device 2 of this embodiment further comprises a storing part 291 and a secondary circuit board 292, which are disposed within a rear end 204 of the main body 20. In addition, a switch 292a is disposed on the secondary circuit board 292. In a case that the cursor control device 2 is in a non-usage state and the wireless signal receiver 26 is stored within the storing part 291, the electric power of the chargeable battery 23 fails to be transmitted to the primary circuit board 21.

In a case that the secondary circuit board 292 and the switch 292a are disposed within the rear end 204 of the main body 20 for controlling whether the electric power of the chargeable battery 23 is transmitted to the primary circuit board 21 or not, the chargeable battery 23 is not directly connected with the primary circuit board 21. Whereas, the secondary circuit board 292 is connected with the primary circuit board 21 and the chargeable battery 23.

In particular, the length of the storing part 291 is larger than the length of the wireless signal receiver 26. If the wireless signal receiver 26 is not stored within the storing part 291, the switch 292a is triggered by the storing part 291 (see FIG. 5). Under this circumstance, the electric power of the chargeable battery 23 can be transmitted to the primary circuit board 21 through the secondary circuit board 292.

When the wireless signal receiver 26 is inserted into the storing part 291, the storing part 291 is pushed by the wireless signal receiver 26. Consequently, the storing part 291 is moved toward the inner portion of the main body 20. Under this circumstance, the switch 292a is no longer triggered by the storing part 291. Consequently, the electric power of the chargeable battery 23 fails to be transmitted to the primary circuit board 21 through the secondary circuit board 292.

The present invention further provides a shape-changeable chargeable cursor control device. In the following embodiment, the cursor control device will be illustrated by referring to a mouse.

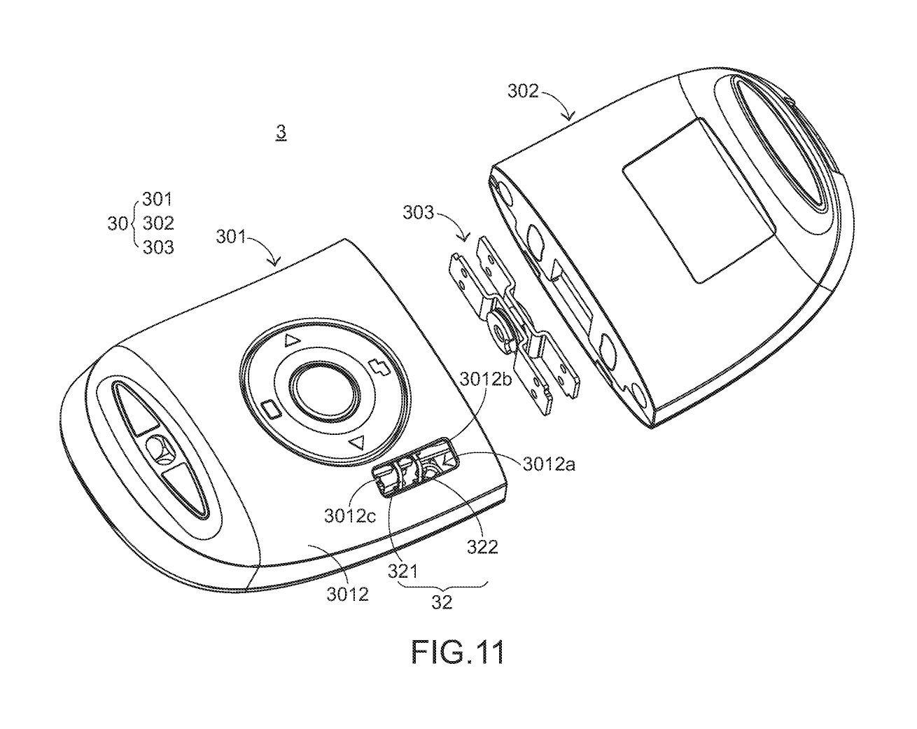

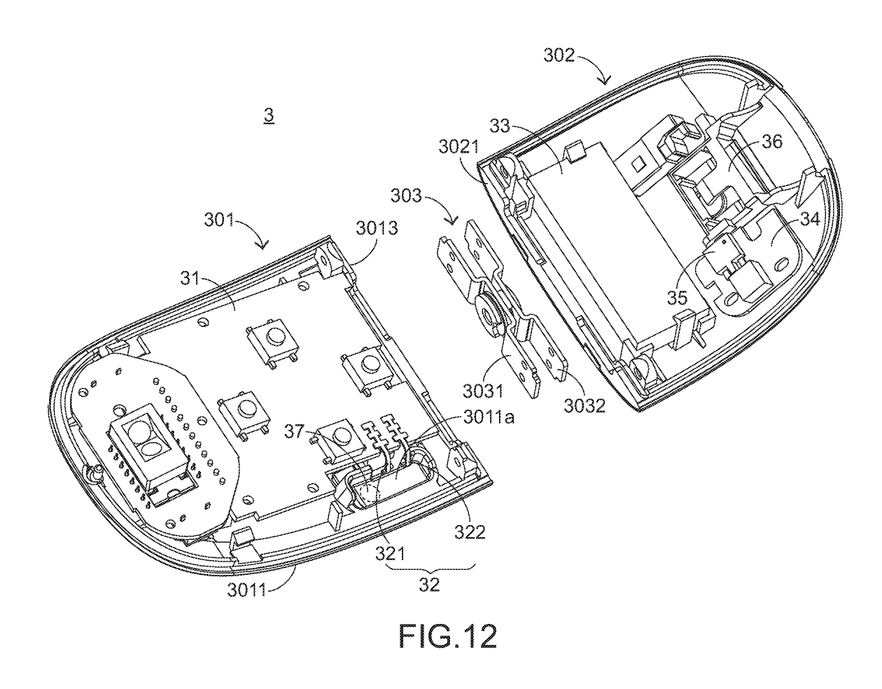

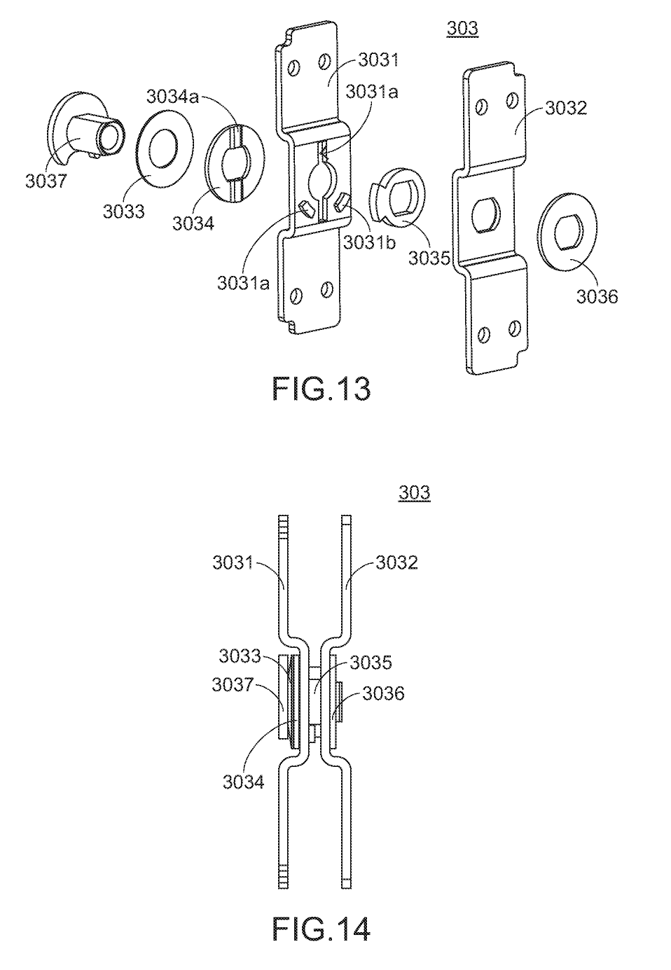

Please refer to FIGS. 11-14. FIG. 11 is a schematic exploded view illustrating the outward appearance of a cursor control device according to a second embodiment of the present invention. FIG. 12 is a schematic exploded view illustrating the inner structure of the cursor control device according to the second embodiment of the present invention. FIG. 13 is a schematic exploded view illustrating a connecting member of the cursor control device according to the second embodiment of the present invention. FIG. 14 is a schematic assembled view illustrating the connecting member of the cursor control device according to the second embodiment of the present invention.

The cursor control device 3 according to the second embodiment of the present invention will be illustrated as follows. The cursor control device 3 comprises a main body 30, a primary circuit board 31, a conducting member 32, a chargeable battery 33, a secondary circuit board 34, a switch 35, and a storing part 36.

As shown in FIGS. 11 and 12, the main body 30 comprises a first casing 301, a second casing 302, and a connecting member 303.

In this embodiment, the first casing 301 comprises a first upper casing part 3011, a first lower casing part 3012, a charging slot 3012a, and a first bulge 3012c. The charging slot 3012a is formed in the first lower casing part 3012. The first bulge 3012c is protruded from an inner periphery 3012b of the charging slot 3012a.

Moreover, a receiving space 3011a is disposed within the first upper casing part 3011. In addition, a first magnetic body 37 is disposed on a bottom of the receiving space 3011a.

Moreover, the cursor control device 3 further comprises a charging slot cover 24 for sheltering the charging slot 3012a. The charging slot cover 24 is rotatable relative to the charging slot 3012a to expose the charging slot 3012a. The structure and the function of the charging slot cover 24 of the cursor control device 3 are similar to those of the charging slot cover 24 as shown in FIG. 3. For clearly illustrating the charging slot 3012a and the inner structure of the charging slot 3012a, the charging slot cover 24 of the cursor control device 3 is not shown in FIG. 11.

The relationships between the above components will be illustrated as follows. Firstly, the primary circuit board 31 is disposed within the first casing 301. As shown in FIG. 12, the conducting member 32 is connected with the primary circuit board 31, and disposed over the receiving space 3011a. In this embodiment, the conducting member 32 comprises a conducting member positive electrode 321 and a conducting member negative electrode 322. Moreover, the conducting member 32 is a resilient sheet.

Moreover, the chargeable battery 33, the secondary circuit board 34 and the storing part 36 are all disposed within the second casing 302. The secondary circuit board 34 is connected with the chargeable battery 33 and the primary circuit board 31 for controlling whether the electric power of the chargeable battery 33 is transmitted to the primary circuit board 31 or not. The switch 35 is disposed on the secondary circuit board 34.

Afterwards, the first casing 301 and the second casing 302 are connected with each other through the connecting member 303, so that the second casing 302 is rotatable relative to the first casing 301.

Please refer to FIGS. 13 and 14. The connecting member 303 comprises a first supporting frame 3031, a second supporting frame 3032, an elastic pad 3033, a cam 3034, a positioning plate 3035, a fixing plate 3036, and a rotating shaft 3037. The elastic pad 3033 is tapered from an end to the other end.

Moreover, the first supporting frame 3031 comprises an engaging groove 3031a and two second bulges 3031b. The cam 3034 comprises a third bulge 3034a.

For assembling the cursor control device 3, the first supporting frame 3031 is connected with a rear end 3013 of the first casing 301, and the second supporting frame 3032 is connected with a front end 3021 of the second casing 302. In addition, the cam 3034 is contacted with the first supporting frame 3031, the elastic pad 3033 is contacted with the cam 3034, the positioning plate 3035 is arranged between the first supporting frame 3031 and the second supporting frame 3032, and the fixing plate 3036 is contacted with the second supporting frame 3032.

Finally, the rotating shaft 3037 is sequentially penetrated through the elastic pad 3033, the cam 3034, the first supporting frame 3031, the positioning plate 3035, the second supporting frame 3032 and the fixing plate 3036. Consequently, the second casing 302 is connected with the first casing 301, and rotatable relative to the first casing 301.

Moreover, after the first supporting frame 3031 and the second supporting frame 3032 are aligned with each other, the third bulge 3034a of the cam 3034 is engaged with the engaging groove 3031a of the first supporting frame 3031, and the cam 3034 is pressed by the elastic pad 3033. Consequently, the cam 3034 is not detached from the engaging groove 3031a (see FIG. 14).

As the second casing 302 is rotated, the rotating shaft 3037, the fixing plate 3036, the positioning plate 3035 and the cam 3034 are correspondingly rotated with the second supporting frame 3032. Consequently, the third bulge 3034a of the cam 3034 is disengaged from the engaging groove 3031a of the first supporting frame 3031, and the elastic pad 3033 is compressed by the third bulge 3034a of the cam 3034. Until the second supporting frame 3032 is rotated by 180 degrees and the second supporting frame 3032 is aligned with the first supporting frame 3031 again, the positioning plate 3035 is stopped by one of the two second bulges 3031b of the first supporting frame 3031, so that the second supporting frame 3032 fails to be continuously rotated. At the same time, the third bulge 3034a of the cam 3034 is engaged with the engaging groove 3031a of the first supporting frame 3031 again, and the elastic pad 3033 is restored to its original shape as shown in FIG. 14.

Especially when the second casing 302 is rotated by 180 degrees relative to the first casing 301, the operating mode of the cursor control device 3 may be switched. For example, the operating mode of the cursor control device 3 may be switched from a general mouse mode to a presentation mode or from the presentation mode to the general mouse mode.

The cursor control device 3 further comprises a wireless signal receiver 26 (not shown). The structure and the function of the wireless signal receiver 26 of the cursor control device 3 are similar to those of the wireless signal receiver 26 of the first embodiment as shown in FIGS. 6 and 7, and are not redundantly described herein.

A process of charging the cursor control device 3 is similar to the process of charging the cursor control device 2 of the first embodiment. Firstly, the outer shell 261 of the wireless signal receiver 26 is introduced into the charging slot 3012a of the first casing 301 of the cursor control device 3. For allowing the outer shell 261 of the wireless signal receiver 26 to be successfully transferred through the charging slot 3012a, the first bulge 3012c protruded from the inner periphery 3012b of the charging slot 3012a should be accommodated within the recess 2611 of the outer shell 261 of the wireless signal receiver 26. Then, the bottom 2614 of the outer shell 261 is inserted into the receiving space 3011a within the first casing 301. At the same time, the second magnetic body 265 of the wireless signal receiver 26 and the first magnetic body 37 are magnetically attracted by each other. Consequently, the outer shell 261 is fixed in the first casing 301.

After the wireless signal receiver 26 is transferred through the charging slot 3012a and fixed in the first casing 301, the connecting terminal 263 is exposed outside the first casing 301 to be connected with the computer 28. In addition, the conducting member positive electrode 321 is contacted with the charging plate positive electrode 2641 of the wireless signal receiver 26, and the conducting member negative electrode 322 is contacted with the charging plate negative electrode 2642 of the wireless signal receiver 26. After the connecting terminal 263 is connected with the computer 28, the electric power from the computer 28 is transmitted to the primary circuit board 31 through the charging plate member 264 and the conducting member 32. Then, the electric power is transmitted from the primary circuit board 31 to the chargeable battery 33 through the secondary circuit board 34.

Moreover, the methods of using the storing part 36 and the switch 35 on the secondary circuit board 34 to control whether the electric power of the chargeable battery 33 is transmitted to the primary circuit board 31 are similar to those illustrated in the first embodiment, and are not redundantly described herein.

From the above description, the present invention provides a chargeable cursor control device. In accordance with the present invention, a first bulge is protruded from an inner periphery of a charging slot, and a recess is formed in an outer shell of a wireless signal receiver. During the wireless signal receiver is transferred through the charging slot, the first bulge is accommodated within the recess. Consequently, the wireless signal receiver is permitted to be transferred through the charging slot in a single correct direction. In other words, it is impossible to insert the wireless signal receiver into the main body of the cursor control device through the charging slot in a wrong direction (e.g. a reverse direction). Consequently, the problems of the conventional chargeable cursor control device will be eliminated. That is, the chargeable cursor control device of the present invention can be effectively charged, and the possibility of causing damage of the charging plate or the conducting part will be minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cursor control device, comprising:
a main body comprising a charging slot and a first bulge, wherein said first bulge is protruded from an inner periphery of said charging slot;
a primary circuit board disposed within said main body;
a conducting member connected with said primary circuit board;
a chargeable battery disposed within said main body, and connected with said primary circuit board; and
a wireless signal receiver to be connected with a connecting port of a computer, wherein said wireless signal receiver comprises:
an outer shell comprising a recess, wherein said recess is formed in a first sidewall of said outer shell;
a receiver circuit board disposed within said outer shell;
a connecting terminal located at an end of said outer shell, wherein when said connecting terminal is connected with said connecting port of said computer, electric power is transmitted from said computer to said receiver circuit board through said connecting terminal; and
a charging plate member connected with said receiver circuit board, and exposed to a second sidewall of said outer shell,
wherein when said wireless signal receiver is transferred through said charging slot, said first bulge protruded from said charging slot is accommodated within said recess of said outer shell of said wireless signal receiver, and said connecting terminal is exposed outside said main body to be connected with said computer, so that said charging plate member is contacted with said conducting member to receive said electric power from said computer and transmit said electric power to said chargeable battery.

2. The cursor control device according to claim 1, wherein said conducting member comprises a conducting member positive electrode and a conducting member negative electrode, and said charging plate member comprises a charging plate positive electrode and a charging plate negative electrode, wherein said conducting member positive electrode and conducting member negative electrode are respectively contacted with said charging plate positive electrode and said charging plate negative electrode to transfer said electric power.

3. The cursor control device according to claim 1, further comprising:
a charging slot cover for sheltering said charging slot, wherein said charging slot cover is rotatable relative to said charging slot; and
an elastic element for providing a restoring force to said charging slot cover.

4. The cursor control device according to claim 1, wherein said conducting member is a resilient sheet.

5. The cursor control device according to claim 1, wherein said cursor control device is a mouse.

6. The cursor control device according to claim 1, wherein said main body comprises an upper body part and a lower body part, wherein said charging slot is formed in said lower body part, and a receiving space is disposed within said upper body part, wherein a bottom of said wireless signal receiver is fixed in said receiving space.

7. The cursor control device according to claim 6, further comprising:
a first magnetic body disposed on a bottom of said receiving space; and
a second magnetic body disposed on said bottom of said wireless signal receiver, wherein when said first magnetic body and said second magnetic body are magnetically attracted by each other, said wireless signal receiver is fixed in said main body.

8. The cursor control device according to claim 6, further comprising a secondary circuit board, which is disposed within a rear end of said main body, wherein said electric power of said chargeable battery is transmitted to said primary circuit board through said secondary circuit board.

9. The cursor control device according to claim 8, further comprising a switch, wherein said switch is disposed on said secondary circuit board.

10. The cursor control device according to claim 9, further comprising a storing part, which is disposed within said rear end of said main body for storing said wireless signal receiver, wherein if said wireless signal receiver is not stored within said storing part, said switch is triggered by said storing part, so that said electric power of said chargeable battery is permitted to be transmitted to said primary circuit board, wherein when said wireless signal receiver is inserted into said storing part, said storing part is pushed by said wireless signal receiver, so that said switch is not triggered.

11. The cursor control device according to claim 1, wherein said main body comprises:
a first casing comprising a first upper casing part and a first lower casing part, wherein said primary circuit board is disposed within said first casing, said charging slot is formed in said first lower casing part, said first upper casing part comprises a receiving space, and a bottom of said wireless signal receiver is accommodated within said receiving space;
a second casing, wherein said chargeable battery is disposed within said second casing; and
a connecting member for connecting said first casing and said second casing, so that said second casing is rotatable relative to said first casing.

12. The cursor control device according to claim 11, further comprising:
a first magnetic body disposed on a bottom of said receiving space; and
a second magnetic body disposed on said bottom of said wireless signal receiver, wherein when said first magnetic body and said second magnetic body are magnetically attracted by each other, said wireless signal receiver is fixed in said first casing.

13. The cursor control device according to claim 11, wherein said connecting member comprises:
a first supporting frame connected with a rear end of said first casing, and comprising an engaging groove and two second bulges;
a second supporting frame connected with a front end of said second casing;
an elastic pad;
a cam comprising a third bulge, wherein when said first supporting frame and said second supporting frame are aligned with each other, said third bulge is engaged with said engaging groove of said first supporting frame, wherein as said second casing is rotated, said third bulge is disengaged from said engaging groove and said elastic pad is compressed by said third bulge;
a positioning plate, wherein as said second casing is rotated, said positioning plate is correspondingly rotated until said positioning plate is stopped by one of said second bulges;
a fixing plate; and
a rotating shaft penetrated through said elastic pad, said cam, said first supporting frame, said positioning plate, said second supporting frame and said fixing plate sequentially, wherein as said second casing is rotated, said rotating shaft, said fixing plate, said positioning plate and said cam are synchronously rotated.

14. The cursor control device according to claim 11, further comprising a secondary circuit board, which is disposed within said second casing, wherein said electric power of said chargeable battery is transmitted to said primary circuit board through said secondary circuit board.

15. The cursor control device according to claim 14, further comprising a switch, wherein said switch is disposed on said secondary circuit board.

16. The cursor control device according to claim 15, further comprising a storing part, which is disposed within said second casing for storing said wireless signal receiver, wherein if said wireless signal receiver is not stored within said storing part, said switch is triggered by said storing part, so that said electric power of said chargeable battery is permitted to be transmitted to said primary circuit board, wherein when said wireless signal receiver is inserted into said storing part, said storing part is pushed by said wireless signal receiver, so that said switch is not triggered.
